(19) United States
(12) Patent Application Publication
(10) Pub. No.: US 2025/0217856 A1
(43) Pub. Date: Jul. 3, 2025

(54) On-Line Systems And Methods For Food And Beverage Critics

(71) Applicant: Drew Alia, Philadelphia, PA (US)

(72) Inventor: Drew Alia, Philadelphia, PA (US)

(21) Appl. No.: 18/401,611

(22) Filed: Dec. 31, 2023

(51) Int. Cl. G06Q 30/0282; G06Q 30/0217

(52) U.S. Cl. CPC G06Q 30/0282; G06Q 30/0217

(57) ABSTRACT

Systems and methods are provided that comprise an app with access to a website comprising critiques and ratings of food and beverages by critics for use by potential consumers. The critics are enabled and compensated for their critiques and ratings that increases the critics' efficiency, organization, usefulness, quality, and rewards using cryptocurrencies. The systems and methods comprise a plurality of computer devices operating the app and interfaced with the critiquing and rating website hosted on one or more computer servers on the Internet and supporting critiques by authorized critics using said computer devices. The app comprises a comprehensive rating system that includes ratings for take-out, delivery, and in-store dining. The app supports displaying on the website reviews and ratings of food and alcoholic beverages, pictures of dishes, menus from restaurants and pictures of each dish, rankings of dishes, delineating rankings by ethnicity, and other information.

### CROSS REFERENCE TO RELATED APPLICATIONS

This application claims the benefit of U.S. Provisional Application Ser. No. 63/421,148, filed on Oct. 31, 2022, which is hereby incorporated by reference herein.

### BACKGROUND AND FIELD OF THE INVENTION

### A. Technical Field

The present invention generally relates to new methods and software applications for computers and other mobile devices, and more specifically to a method that uses a software app to provide a new platform for an on-line community of food and beverage critics to critique and rate the many establishments they have frequented or will frequent in the future and new methods for compensating the critics to support their efforts and provide useful information to consumers.

### B. Description of Related Art

Food and beverage critics often post reviews to on-line resources. Typically, they critique and rate the many establishments they have frequented and post a picture of the dish or beverage for use in a rating system to rate the dish or beverage. They may also be able to critique and rate take-out food, delivery, meal prep kits, meal prep services, alcoholic beverages purchased in the liquor store and in restaurants and bars, and the meals or homemade recipes they cook. These postings (e.g., Yelp postings) are not efficient in application, high quality is not fostered, and high reward is not proffered to the most useful and meritorious critics and critiques. The on-line experience sought by many users is lacking in terms of the critics (e.g., the lack of highly compensated and skilled newspaper and magazine reviewers of the past, many of whom were famous) and the organization and accessibility of the reviews on favored devices (e.g., smartphones, laptop computers). Presently, there is no system or method to accomplish the efficient, well-organized, high quality, and highly rewarding postings of critiques and ratings online.

Therefore, there is a need for a method and associated software app that provides, among other things, a platform for the on-line community of food and beverage critics to critique and rate the establishments they visit that is efficient, of high quality, and that is highly rewarding to the critics.

### SUMMARY OF THE INVENTION

The present disclosure provides a method that uses a software application—an app—that can be used to post reviews and critique of bars drinks, restaurant menu items, and/or homemade recipes onto an Internet website.

Certain embodiments of this invention may include a computer network operating a software app for critiquing and rating food and beverages comprises a plurality of computer devices operating the app and interfaced with a critiquing and rating (e.g., ranking) website hosted on a computer server on the Internet and supporting critiques by authorized critics using said computer devices. The app comprises a comprehensive rating system that includes rating for take-out, delivery, and in-store dining. The term comprehensive as used herein means at least 5 attributes of an establishment, and is preferably at least 7 and most preferably at least 10. The app supports displaying on the website, and/or providing a graphical user interface (“GUI”) to allow a user to view, access and/or interact with the app platform, at least-reviews and ratings of food and alcoholic beverages, pictures of dishes, menus from restaurants and pictures of each dish, rankings of dishes, delineating rankings by ethnicity comprising at least Indian, Chinese, Greek, French, and Italian dishes, aggregate best dish ratings by categories comprised of at least steak, pizza, burgers, and seafood, pie charts of data, top 100 most popular and highest rated dish by locale, and restaurant rankings, including rankings by locale.

The manner in which the postings are provided in preferred embodiments is efficient, searchable, geographically relevant, organized, and useful for the public (i.e., users, followers, potential consumers of the food and beverages, which terms are used interchangeably herein). The app fosters high quality postings by providing the critics with a facile system for organizing and presenting their critiques and ratings that will be favored by potential consumers of the food and beverages. In certain embodiments, the system may also foster high quality postings by providing compensation systems that overcome at least in part the high cost of purchasing the food and beverages that are being reviewed, which may be inhibiting to new critics and/or to obtaining a favorable quantity of high quality, well-written, well-researched and well-thought-out reviews of various eateries (i.e., bars, restaurants, food windows, food trucks, food delivery services and other eating and/or drinking establishments and providers, which terms are used interchangeably herein), including expensive ones.

The app is highly rewarding to critics with certain of its embodiments with its facile system for organizing and presenting their critiques that will be favored by users. In addition, in certain embodiments, the system may provide compensation systems that overcome at least in part the high expenses of purchasing the food and beverages that are being reviewed. In the past, newspapers and magazines provided compensation and expenses to a very small number of critics. This system did not carry over to the on-line experience of many users of the Internet, who could benefit from more points of view in a medium (e.g., smartphone, laptop computer) they prefer for several possible reasons, including convenience.

In certain preferred embodiments, a method of obtaining a critic's critiques and ranking information of food and beverages sold by a bar and/or restaurant is provided. The method comprises providing a software app to the critic on a smartphone and/or laptop computer, the software app comprising queries for the critic to answer. The queries to answer comprise queries concerning critiques of the food and the beverages, ratings (e.g., rankings) of the food and the beverages, pictures of the food and beverages, menus listing the food and beverages, and type of ethnicity of the food and beverages if any. The method also comprises uploading the query answers to one or more computer servers, processing the query answers, and providing the processed query answers to an organized, searchable, accessible website. In addition, the method comprises compensating the critic for the query answers in a manner that allows the critic to claim a profit and deduct at least a portion of the critic's expenses undertaken to provide the query answers under the tax laws of the United States and/or a state of the United States. In certain of these preferred embodiments, the compensation comprises stock in a corporate entity and/or crypto currency.

In certain other embodiments, a method of obtaining a critics review of art, books, furniture, movies, vacation spots, deodorants, cleaning products, critiquing food based on whether or not it is safe to eat, toothpastes, paper towels, toilet paper, etc. The same process applies whereby the critic receives crypto for each review they post.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWING

FIG. 1 is a schematic diagram illustrating some connections between components of certain embodiments of this invention.

### DETAILED DESCRIPTION OF EMBODIMENTS

A description of embodiments of the present invention will now be given. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### First App

In an embodiment, the software application (app) provides a platform for an on-line community of food and beverage (e.g., alcoholic beverages, coffees) critics who critique and rate the many establishments they have frequented or will frequent. The app interfaces with a website hosted on an operating computer server on the Internet. The disclosed platform may also provide a graphical user interface (“GUI”) for providing an interface for a user to view, access and interact with content and features of the system for critiquing food and drink. The critics can then post a picture of the dish or beverage and use a comprehensive rating system to rate the dish or beverage on the website. The critics can also critique and rate take-out food and delivery and grocery items and recipes that they have cooked using those groceries.

The company marketing/owning (i.e., the Company) the first app in certain embodiments can employ hundreds or even thousands of “employees” as independent contractors (IC) or non-independent contractors of food and beverage critics in most cities across the United States and around the world. The Company operates the website, which can interface with various computerized devices, such as a smartphone, running the app.

Independent Contractors (ICs) in certain embodiments can form LLCs and make a business out of critiquing each dish they try. ICs will essentially be food critics, and the ICs will have to pay a one-time fee for the formation of their own LLC. The IC can be spread out throughout the entire U.S. and the world. The larger the city, the more ICs can be employed. There are a finite number of ICs envisioned. ICs can be assigned a geographic territory within which they dine to provide critiques.

Non-Independent Contractors (NIC) in certain embodiments can also be able to post pictures and comprehensively rate each dish or beverage, but the NICs will not be employed as independent contractors of company, will not be required to have an LLC and will not be able to write off their expenses. There will not be a limit on how many NICs can sign up. In an embodiment, when an IC/NIC posts a review, posts can appear on an IC/NIC profile page and elsewhere on the app.

In an embodiment, each app user can have a main “wall” where the dishes/beverages of IC/NIC they have chosen to follow, will show up.

In an embodiment, there can be an overall IC/NC Leaderboard (based on the number of followers) per cuisine, best diet critic, per nutrition, per healthy dishes, per entire city, state, country, worldwide.

In an embodiment, each IC/NIC can have a profile page: description of main job, ethnicity of IC/NIC, hometown, age, name of LLC at top (only applies to ICs), picture of IC/NIC, several pie charts mined from the IC/NIC's eating habits, total post number, % of posts from the city where they live (city of origin), followers number, at least 5 pie charts, (cuisine, specific food type, {percentage of posts, $, $$, $$$, $$$$}, percentage of posts from, IC/NIC hometown, and year to date spent on food and beverage).

In an embodiment, followers and non-followers can be able to like and leave comments on the IC/NIC posts.

In an embodiment, the Users page can be your city, or location where you currently are, and can consist of a real time feed, not of your followers, but of what everyone in your location/city is currently posting right now. There can also be a “most recent” popularity of the IC/NIC that you chose to follow and of the users who follow you.

In an embodiment, the app provides a comprehensive rating (e.g., ranking) system that can include some or all of the following:

For take-out: picture, taste/delicious, packaging, wait time (in store in general) correct order, etc.

Delivery categories: delicious/tasty, packaging, wait time, correct order, correct temperature of food, picture, etc.

### In-Store Rating; Delicious/Taste, Staff, Cleanliness, Ambience, Bathroom Cleanliness, Service, Etc.

The IC/NIC can also be given an opportunity to write a review. Instead of using a 5-star rating system, the app can use a different rating system in certain embodiments (e.g., 5 sun rating system (suns are stars)).

Utility for Users (e.g., Non-Critics who are just using the app to find something good to eat or drink or who choose to follow the Critics)

Some or all of the following can be provided to users with certain embodiments of this invention:

Feature: Menus: Using crowd sourced data, provided by the IC/NICs who post pictures/reviews, the app can map some, most, or all restaurant menus and populate a particular restaurant's menu most popular, first to last; highest rated from first to last.
1a. Feature: Goal of the app using crowd sourced data aggregation is to have more menus mapped, and user can pull up a restaurant menu and visually see each dish, in the same or a similar manner in which Google can map each and every street, and thus the technology is available for mapping every menu.
1b. Restaurant Browsing: Users can peruse through the restaurant page on a company web site (each restaurant will have their own page) and the various pics or utilize the first to last ranking of menu items. The web site can act as a visual on-line menu for the restaurant. The app can help users at home decide what or where they want to eat.
1c. Dish Appearance: Users can access pictures of reviewed dishes on a restaurant menu entered on the web site.
2. Feature: Dish Ranking: The app can rank most popular dish (most rated dish; ex, “this dish was rated 10,763 times.”), highest rated (99% of posts rated 5 stars, etc.) in a particular city. This feature can also be populated to rank most popular, high rated, by budget ($, $$, $$$, $$$$). This feature can also be able to populate most popular, high rated by cuisine (Italian, Indian, Chinese, etc.), by nutrition, by vegan, by fast food, by most healthy, etc.
2a. Visitors: Not only does this feature help users from the same city as the restaurant, but it can help users who are travelling or who are from out of town. Visitors from out of town can find the app useful for gauging what restaurant and dishes are popular. They can easily find the best dishes in town for their budget and/or desired cuisine. Typically, only locals know the best spots in town; this app addresses this problem.
2b. Foreign Travelers: The app can also be useful for those who travel to a different country or for curious users in the U.S. who want to know the most popular/highest rated dishes in New York City, Rome, London, Moscow, Istanbul, Vienna, etc.
2c. Best Dishes: By using the crowd sourced data gathered by the ICs/NICs, the app can gauge, with precision, accuracy, and exactness, which restaurant has the best dish. The app can support the best rated steak, pizza, burger, salmon, seafood, etc. Eventually, the crowd sourced data generated can show, irrespective of fallible critiques (who base the best on personal opinion, a review of a single magazine critique, a small unspecific poll, or a crooked critic who was given a kickback to award the best burger to a preselected establishment) which restaurant has the best of what dish, as “numbers don't lie.”
2d. Local Best Dishes: The feature of who has the best dish can be populated by city, state, country, within 2 miles, within 5 miles, within 15 miles, etc.
2e. Most Popular/Highest Rated: The app can also allow the users to see the top 100 most popular and highest rated dish. This feature can also break down dishes by budget ($-$$$$) and location/city.
3. Feature: Restaurant Ranking. The app will rank what restaurants are rated the most (most rated). Most rated can mean the restaurant is most popular. The app can also rank the restaurants who have the highest rating (average of 4.8 stars out of 5). This feature can also be broken down into $, $$, $$$, $$$$. This feature ranks restaurants compared to dishes IC/NIC.
3a. Rating Stats: Can be useful to those looking for a good place to eat on the main restaurant page; comprehensive rating system results for that restaurant, aggregated from all of the IC/NICs; populate most popular, vs. highest rated.
4. Feature: Follow Critic: Users can select to follow ICs/NICs. The app can also allow users to populate most popular food critics (ICs/NICs) based on the number of followers.
4a. Feature: Selecting Critics: Users will be able to populate and follow IC/NIC based on eating habits: cuisine, most healthy, IC/NIC, budget (some ICs/NICs will have a high number of $ posts, some will have a high number of $$$ posts), ethnicity of IC/NIC (Italians know where to get the best Italian food etc.); (See pie chart info in 4b.).
4b. Feature: Pie Charts: Each IC/NIC will have a profile page with, among other things, features pie charts. One pie chart can graph cuisine, one pie chart can graph specific food types (chicken 20%, steak 10%, fish 5%, pizza 25% etc.), one pie chart can graph what % of posts were $ vs. $$$, etc. (Cuisine: Italian, Greek, French, Chinese, Indian, etc.).
4c. Popular ICs/NICs. Some ICs/NICs will have many followers (increased followers popular ICs) and some will have a high % of $ posts. Users will find it beneficial to follow popular ICs/NICs and some will find it useful to know the best $ places (inexpensive dishes). Based on the pie charts, some ICs/NICs will have high $$$ taste preferences. Users will find it beneficial to know the best inexpensive places. As another option, IC/NIC who are of a particular ethnicity may be followed for ethic food, e.g., who better to rate Chinese food than an ethnic Chinese critic (or Greek ethnicity for Greek food; Indian ethnicity for Indian food; etc.). In all cases, users can follow who has expensive taste, who eats healthy, etc.
4d. Based on IC/NIC pie charts, if an IC/NIC eats 35% fish, as user who wants to know the best fish spots can follow that IC/NIC.
4e. Based on pie chart information, the app can allow populating the most popular IC/NIC based on $-$$$$, cuisine, nutrition, healthy eating habits, useful to users who are watching their budget and their health, etc., or who are on a diet.
4f. Diary: IC/NIC who have an interest in a diary-like app can keep track of their eating habits; the pie charts can help with setting up and maintaining the diary.
5. Feature: Users can click on the “most recent” icon and the most recently posted dish posted by the IC/NIC will appear on the feed in the city where they currently are; or they can change the city to where they are going.
5a. Post “Wall”: There can be a “wall” where all the ICs/NICs who actively post, will show up and the user can have a wall consisting of only the posts of the ICs/NICs they chose to follow.
5b. Feature: “Most recent” icon; the user might find this feature useful to see what restaurant is still open; if a dish appears, the restaurant is still open.
6. Feature: Ethnicity: When signing up, the IC/NIC can be asked to check an ethnicity box. Then, if a user likes Indian food, he can follow an Indian IC/NIC; the same will be for Italian, Greek, Chinese, etc.—ICs/NICs. Users will find this useful because typically speaking, Italians know the best Italian restaurants, Chinese know the best authentic Chinese restaurants, etc.
7. Feature: the app will have a Wikipedia-style feature whereby the IC (not the NIC) will be able to update information on the restaurant in real time, such as, hours of operation, items no longer available on the menu, new items, specials, etc. This is useful to users because it fixes the problem of non-updated information on restaurant sites or Yelp who often have wrong hours of operation or non-updated menu information.
8. Feature: Search Dishes: A search box on the app for type/name of dish can support finding desired dishes.
9. Feature: Likes: The app can allow the IC/NIC OR users to populate the most popular and highest posted dishes based on overall likes or individual likes from followers.
10. Feature: Aggregate/Ranking: The app can allow users to aggregate and rank IC/NIC who have highest percentage of vegan diet, or fish, or organics, etc. Users may have an interest in the best IC/NIC who are pescatarians, vegetarians, etc., and then follow them.
11. Feature: Restaurant Pages: Each restaurant listed can have its own page which can include a picture of each dish or some of the dishes offered. Under the picture, there can be a numerical figure notating the number of times that it has been rated and the aggregate/average number of suns/stars received. This is useful because it will help in the decision-making process.

### GUI for Users

In an aspect of the disclosure for a platform for critiquing and rating food and beverages by a user, a GUI may be provided. The GUI, as implemented by the disclosed platform, will also solve the age-old question faced by people every night which is-what should we have for dinner? The users of this site can quickly find the best restaurants and follow food critics that they are interested in.

Graphical user interfaces facilitate user interaction with computing devices that implement the disclosed platform for critiquing food and beverages by a user, by way of graphical elements (and in some cases display links to audio elements as well), instead of through use of a pure text-based interface. These graphical elements may include windows, icons, widgets, sliders, text boxes, buttons, and menus that can be selected, highlighted, moved, and so on through use of a pointing device (e.g., a mouse). Modern smartphones, tablets and wearable devices expand these features to support touch and multi-touch manipulation. Often, two or more screens of a graphical user interface are linked together into a workflow. Navigation between these screens may be possible in particular orderings. Graphical user interfaces that implement the disclosed platform may be web-based, for example, with parts of each page being loaded from a server and/or a database, or natively-compiled to execute on a client device even when no network is available.

The disclosed GUI will also solve the problem associated with every food critic until now-you are getting the opinion of one critic. This is usually one person's opinion who writes for a magazine or column, it is the view of only one person, its one person's opinion. Whereas with the site, if several hundred or thousand people rate the burger or cheesesteak, an algorithm implemented by the disclosed platform will return a much more accurate representation of how good or bad the food really is. The GUI may include, without limitation, a GUI element for displaying and allowing the user to access reviews and ratings of food and alcoholic beverages; a GUI element for displaying and allowing the user to access pictures of dishes; a GUI element for displaying and allowing the user to access menus from restaurants and pictures of each dish; a GUI element for displaying and allowing the user to access rankings of dishes; a GUI element for displaying and allowing the user to access delineating rankings by ethnicity comprising at least Indian, Chinese, Greek, French, and Italian dishes; a GUI element for displaying and allowing the user to access aggregate best dish ratings by categories comprised of at least steak, pizza, burgers, and seafood; a GUI element for displaying and allowing the user to access pie charts of data; a GUI element for displaying and allowing the user to access top 100 most popular and highest rated dish by locale; and a GUI element for displaying and allowing the user to access restaurant rankings, including rankings by locale. Other features, elements and information of interest or utility, such as those described above for Utility for Users, may be implemented by the GUI to enhance the accessibility and ease of use for a user.

### Utility for ICs

Some or all of the following can be provided to IC's with certain embodiments of this invention:
1. A great advantage for each IC with certain embodiments is that they may be able to write-off 50% of their meals on their taxes for each dinner, food delivery, take-out order, beer and alcohol order, meals cooked, meal prep services etc. This expense can be substantial, and inhibit the acquisition of high-quality reviews, high quality reviewers (i.e., critics) and of expensive eateries. The IRS allows a business owner to write-off all “ordinary and necessary business expenses.” ICs main business is that of being a food critic, and critiquing and reviewing food should be considered an ordinary and necessary expense of doing business. However, under the IRS Restaurant Critic ruling (and similar such rulings or business impediments that may be brought in applicable jurisdictions):
Section 274(n) generally provides, with a few limited exceptions, that a deduction for any expense for food or beverages is limited to 50 percent of the amount of the expense. This limitation reflects Congress' view that meal expenses inherently involve an element of personal living expenses: Generally, some portion of business meal and entertainment expenses represent personal consumption (even if the expenses serve a legitimate business purpose). The committee believes that denial of some part of the deduction is appropriate as a proxy for income inclusion of the consumption element of the meal or entertainment.

Such a system provides high reward to the ICs, and encourages them to spend more time on their reviews, provide more reviews, provide reviews of expensive eateries, and increases the quality of the reviews and of the merits and quality of the system overall. However, there is one more element to being able to write-off one's business expenses; see 5a below.
2. Feature: Profile Pie Charts: Each IC will have a profile page that can include several pie charts depicting the eating habits of the IC. One pie chart can have cuisine (10% Italian, 50% fast food, 5% Chinese, 10% Indian etc.). Another pie chart can have details on food type; 10% fish, 20% chicken, 30% red meat, 10% vegan etc.; a third pie chart can detail budget spent-10% $$$$, 60% $, 57% $$$, etc. The app can also chart dish data.
2a. This feature is useful to ICs, because it can help them keep track of what they are eating. ICs, who are on a diet or who are trying to eat healthy, or who are on a budget, can find this information useful.
3. Feature: Business Profile Page: Each IC can have a business profile page which lists pictures of each dish, each delivery order, each craft beer, etc., and a comprehensive rating system for each post. A lot of ICs, similar to users of Facebook, will feel compelled to post details of their eating experiences, and this app provides a forum for each IC to “show off” their “high class” eating habits into a portfolio on their profile page.
4. Married/Domestic Partner Accounts: Couples can partner together on the LLC and enjoy the write-off together when they file “married” or “jointly.”
4a. For example, writing off the cost of dinners can reduce their adjusted gross income as it would for “unmarried” individuals filing alone, possibly allowing them to reduce their taxable income from the $90,000 tax bracket at 25% down to the 12% tax bracket, based on current tax code. The same will be for individuals with a $45,000 tax bracket (greater than $45,000=25% tax bracket and under $45,000=12% tax bracket, which is a significant difference.
5. Compensation: As compensation, the Company can pay ICs. In certain preferred embodiments, the ICs are paid in shares of the Company. The number of shares given to an IC can be directly proportional to how many posts an IC member makes. The company can deed over shares of “COMPANY” INCORPORATED to the IC only. Non-independent Contractors (NIC) may not receive shares for posting/reviewing a restaurant/bar.
5a. Please note, without a revenue stream or path to profitability for the IC, the IRS will label the ICs food critic business a “hobby” and may not allow LLCs to write off purchase of dishes and beverages. Therefore, without this app, there are very few ways to monetize the career of a food critic. This app allows them to write-off dinners, take-out, delivery, etc., thus, the IC and Company are in a symbiotic relationship with each other. The app is essential if the IC wants to work as a food critic and write-off the things that they critique.
5b. Feature: ICs will be continually accumulating shares of the Company with each post. ICs will be able to sell off shares from time to time, especially after the Company goes Public/has a public offering (IPO).
6. Feature: Followers: Users of the app will be able to follow ICs/NICs that they feel appeal to this taste in food/drink. ICs with a large number of followers (aka food critiques who are popular) may very well be pursued by restaurants who desire to have ICs critique/rate some of the dishes on the menu so that the dish shows up on the ICs feed and provides restaurants with advertisement/exposure.
6a. ICs with a large number of followers may even get discounts from restaurants as some IC critics may have garnered many followers interested in their eating preferences.
7. Feature: Bonus: The goal of the company is to map, with a picture, each menu item and taste it. If some menu items are not rated, the Company can offer more shares to rate (e.g., 1.5×).
8. Feature: Map Balloons: IC can have a feature on their profile page to map out each restaurant/bar visited within a balloon icon on a location map. This is useful because if you are constantly dining in center city Philadelphia, for example, you will know that it is time to broaden your experiences and branch out to other locations.

### Additional Utility for ICs by Some Embodiments

Described above were embodiments where ICs are provided with compensation, such as shares of stock in the Company, as payment for their critiques. In addition, or in substitution in whole or in part for the compensation mechanisms described above, some or all of the ICs may be compensated at least in part with the issuance of a crypto currency created by the Company. With a demonstrated value of the crypto currency, the ICs may be able to establish a business profit and thus avoid an IRS “hobby” label, which may improve the reward for, and quality of, the critiques and the critics, as described above.

For the purposes of the disclosure, though describing an example definition and not a limiting definition, “cryptocurrency,” sometimes called crypto-currency, crypto currency or crypto, is any form of currency that exists digitally or virtually and uses cryptography to secure transactions. Crypto currencies don't have a central issuing or regulating authority, instead using a decentralized system to record transactions and issue new units.

Crypto currency is a digital payment system that does not rely on banks to verify transactions. It is a peer-to-peer system that can enable anyone anywhere to send and receive payments.

Instead of being physical money carried around and exchanged in the real world, cryptocurrency payments exist purely as digital entries to an online database describing specific transactions. When you transfer crypto currency funds, the transactions are recorded in a public ledger. Cryptocurrency is stored in digital wallets.

In these embodiments, the Company forms its own crypto currency and offers it to the ICs in exchange for their posts. In certain of these embodiments, the Company will offer the crypto currency to ICs that make each post. Whenever the IC posts a review, they will be awarded crypto. ICs that make the most posts, the highest quality posts, the highest rated posts, or some combination of these and other measures will also get awarded crypto. This may put the ICs on the path to profitability enabling them to continue to be able to write-off the food and beverages that they review. Such a system where ICs are awarded crypto will encourage high quality posts/reviews, high quality IC food critics, and high rewards for ICs, among other advantages.

In certain of these embodiments where the Company forms its own crypto currency, a certain number of coins—a finite amount—will be minted (e.g., similar to Bitcoin's announcement that it will cap its coins out to 21M in the year 2140) in at least one of three ways:
(1) by mining them using computers which entails massive, decentralized networks of computers all over the world that verify and safeguard blockchains, which are virtual ledgers that record the Companies crypto transactions. or (2) by critiquing food and/or beverage and posting the review for the benefit of the Company, or by critiquing and posting a recipe for the benefit of the Company. The Company will use one or more algorithms conformed to this invention (e.g., as described in U.S. Pat. No. 10,614,430 (which is incorporated by reference herein) and in other methods known to a person of skilled in the art, none of which have been applied to the methods of this invention before) to mint the newly created crypto and award that crypto to the Critics who post reviews. Certain embodiments of the algorithms will also be created to fluctuate how much crypto will or should be awarded to the Critic, this amount will fluctuate as the price of the Companies crypto coin goes up and down or (3) by issuing a participating restaurant or bar crypto from the Company when the restaurant or bar agrees to accept the crypto from the Critic as a form of payment for the food or beverage. This will also give the Companies crypto more utility or usefulness.

In one embodiment, the more followers a particular IC has, the more crypto that Critic ICs may get awarded for each review they post compared to those with less followers.

The crypto currency in certain of these embodiments may also be used and accepted by the bars and restaurants involved in the system, and be used, for example, to purchase food and beverages on behalf of the IC's. In some embodiments, the restaurant that accepts the coin will receive cryptocurrency from the Company as well.

In some embodiments of this invention, the app provided is strictly for food and beverage critics to access and provide content. In certain of these embodiments, when a critic posts to the app and rates food and/or drink, the content of the post will also post to the critic's other social media platforms (e.g., Instagram, Facebook).

The crypto in certain embodiments will also trade alongside of other cryptocurrencies on the many cryptocurrency exchanges in use today. While trading it will fluctuate up and down but should put the Critic on the path to profitability which in turn prevents the IRS from deeming their business a hobby which in turn allows the Critic to continue writing off their food and beverages.

Unlike the vast majority of crypto currencies being traded on exchanges today, the crypto offered by the Company will actually have utility. The crypto being offered by the Company will have utility because it is the linchpin in the entire process that will help the Critic stay in business because without a source of income, the IRS will label their business a “hobby” and forbid them from making any more write off therefore essentially closing down their business.

The Company will also mint new (or send crypto coins already in circulation) to restaurants and bars that agree to accept the Company's crypto as a form of payment from Critics. This will also give the Companies crypto more utility or usefulness as it can be used in transactions between Critics and participating restaurant and bars.

### Utility for Restaurants and Bars

Some or all of the following can be provided to restaurants and/or bars with certain embodiments of this invention:
1. The food and beverage industry can benefit from this app because more people, knowing they can write-off their meal, will dine out more.
2. Feature on app: Each restaurant will have their own home page with the results of all the ratings aggregated by all the various ICs/NICs. A user will be able to populate the most popular dish or highest rated dish from best to worst. This info is useful to restaurants as it will allow them to remove unpopular or low posted products from their menus.
2a. Bars and restaurants will be able to clearly identify and remove the weakest menu items based on lackluster reviews/crowd sourced data from the ICs/NICs.

### Utility for Advertisers Who Pay to Advertise on the Website

Some or all of the following can be provided to advertisers with certain embodiments of this invention:
1. Feature: App can track of what percentage of IC/NIC posts are $, $$, $$$, $$$$. This information can automatically appear in the pie charts budget on each IC/NIC profile page. Based on spending habits of IC/NIC (wealthier ICs/NICs will average more expensive eating habits and vice versa), advertisers can use this mined consumer data to target both wealthier or not so wealthy ICs/NICs and their followers.
2. Feature: App can track the user's and/or IC/NIC's behaviors on many aspects of their reactions to different food, beverages, bars and/or restaurants. This information can be used to identify where advertising investments and improvements are best needed.

### Utility for Non-Independent Contractors (Who Post but Who are not Employed by the Company)

In certain embodiments, a distinction is made between ICs and NICs. NICs will have all the benefits of ICs, with two exceptions: 1) The NICs cannot receive compensation in the form of Company shares (or crypto currency, in certain embodiments) nor 2) can NICs write-off food or drink expenses.

### Second Feature of App—Chefs and Amateur Cooks

A second app, or built into this same app as a different feature, can be initiated that provides a platform for an on-line community of cooks who post the recipe or a video of the recipe and post them on the app along with the end product.

The website can provide almost identical features to the first app in that the second app will have ICs/NICs and offer similar features but for cooks to feature menu dishes they prepare.

The company marketing/owning (i.e., the Company II) the second feature of the app will be incorporated and employ IC cooks who may also want to file an LLC.

The chefs and amateur cooks will also receive crypto or can “mine” the Companies crypto by posting a review and or picture and or recipe of what they cook. By allowing chefs and amateur cooks to review the meals they create, and by issuing them crypto for doing so, they will also be allowed to write-off the groceries/ingredients used in this process as long as they are on the path to profitability and that will only happen if the crypto currency fluctuates up and down.

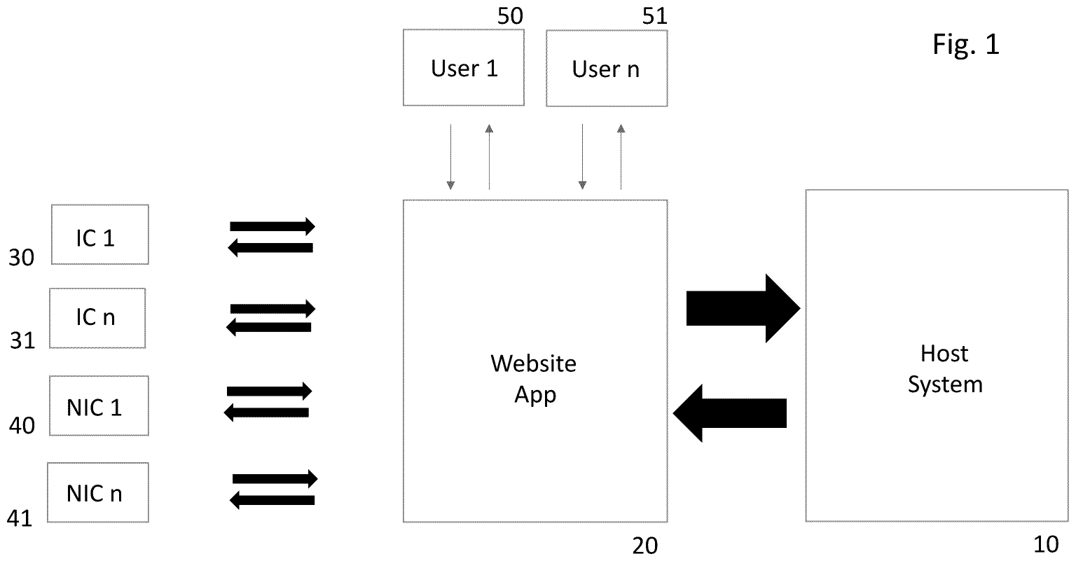

FIG. 1 is a schematic illustrating some of the components used in certain embodiments of this invention. In these embodiments a Host System 10 supports (e.g., receives input and provides output) to a Website App 20. The Website App 20 in turn receives input and provides output from a number of sources. This can include one or more Independent Contractor critics (IC 1 through IC n as represented in FIG. 1) shown as 30 and 31. This can also include one or more Non-Independent Contractor critics (NIC1 through NIC n as represented in FIG. 1) shown as 40 and 41. This can also include one or more Users (e.g., users seeking to learn information about an establishment or food) (User 1 through User n as represented in FIG. 1) shown as 50 and 51.

### Example 1

An entity in a certain location in the United States (e.g., a particular county, town, city, state or region) that practices embodiments of this invention has access to one or more computer servers that in turn have access to the Internet. The one or more servers host a website that can be accessed by an app. The app can be used by critics to provide, among other things, critiques of food and beverages for potential consumers of such to be read on the website. The app is available for smartphones, laptop computers and desktop computers and it can be downloaded by critics and potential consumers (e.g., from an Apple or Samsung app store), although different components of the app (or different apps altogether for critics versus potential consumers, in some embodiments) are accessible to the critics (i.e., the provision of the actual the critiques and the ratings) than are available to the potential consumers (i.e., the reproduction of the critiques and the ratings provided by the critics). The website contains, among other things, the critiques and ratings of food and beverages available from bars and restaurants. In particular, the website comprises a comprehensive rating system that includes ratings for take-out, delivery, and in-store dining. The website displays at least-reviews and ratings of food and alcoholic beverages, pictures of dishes, menus from restaurants and pictures of each dish, rankings of dishes, delineating rankings by ethnicity comprising at least Indian, Chinese, Greek, French, and Italian dishes, aggregate best dish ratings by categories comprised of at least steak, pizza, burgers, and seafood, pie charts of data, top 100 most popular and highest rated dish by locale, and restaurant rankings, including rankings by locale.

To encourage the critics to provide the most favorable quantity of critiques, higher quality critiques, and to obtain higher rewards, the critics are compensated by being paid by the entity for their critiques with stock in the entity and/or a crypto currency provided by the entity. Thus, in this example, a critic visits a restaurant and collects information concerning the review and rating of the food and beverages, pictures of dishes, the menu, and other descriptions of the experience. The critic may also provide information on the restaurant's popularity in general, popularity of dishes, ethnicity, location, and other possible ranking information. The critic uploads this information, including a critique (e.g., review) and ranking of the restaurant, to the app of this invention. Once received and processed for displaying on the website, the entity then compensates the critic with an agreed to amount, such as cash, stock in the entity, and/or crypto currency from the entity. To encourage the highest quality reviews and reviewers (critics), the compensation is provided in such a manner that the critics can best benefit from the provisions of the tax laws of the United States, one or more states of the United States or some other jurisdiction in declaring profits and/or deducting expenses.

### Example 2

In this example, a method of obtaining a critic's critiques and ranking information of food and beverages sold by a bar and/or restaurant in a certain location of the United States or a different country is provided. This method, with its advantages and incentives, provides better organized and useful reviews and ratings, higher quality critiques, and more rewards for the critics.

The method comprises providing a software app to the critic on a smartphone and/or laptop computer, the software app comprising queries for the critic to answer. The queries to answer comprise queries concerning critiques of the food and the beverages, rankings of the food and the beverages, pictures of the food and beverages, menus listing the food and beverages, and type of ethnicity of the food and beverages if any. Other queries may be provided depending on what information may be deemed to be useful to the potential consumers of the food and/or beverages, which may include information concerning the ambiance, service, take-out, delivery, eat-in experience, wait time, ratings, location, parking, wheel-chair accessibility, and other descriptions and features.

The method also comprises uploading the query answers to one or more computer servers and processing the query answers and providing the processed query answers to a website. The website may also be accessible to the potential consumers of the food and beverages or may use the information to decide on where to go.

In addition, the method comprises compensating the critic for the query answers in a manner that allows the critic to claim a profit and deduct at least a portion of the critic's expenses undertaken to provide the query answers under the tax laws of the United States and/or a state of the United States or other region of the world. In certain of these preferred embodiments, the compensation comprises stock in a corporate entity and/or crypto currency. This aspect of certain embodiments is important in increasing the quality and scope of the critiques by providing the critics with a potential for a more lucrative standard of living and ability to focus and develop their skills in providing meaningful critiques. The time of the famous, highly skilled and highly compensated newspaper and magazine food critics may be over, and before this invention, there was no similar method to provide better and more rewarding critiques by critics.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

### Example 3

An entity in Philadelphia purchases one or more computer servers, or access to such servers, in order to provide a food and beverage related website and computer network according to this invention. The website is created with the GUI, content and feedback systems of Examples 1 and 2 above and as described below.

Specifically, this social networking site solves the problem facing the majority of food critics—how can I make a living as a food critic? Food critics can only stay in business if they are generating income/money. Otherwise, after a few years, the IRS will label their “business” a hobby and will not allow them to operate their business to the extent that they will not be able to write off the food and beverages that they critique.
2a. By issuing a GUI and computer software system to automatically issue the critic cryptocurrency, the embodiments of the invention solve the problem that the majority of food and beverage critics face, which is how can one generate income, sustain the business and avoid the IRS hobby label.

The GUI will also solve the age-old question faced by people every night which is—what should we have for dinner? The users of this site can quickly find the best restaurants and follow food critics that they are interested in.

The GUI will also solve the problem associated with every food critic until now. You are getting the opinion of one critic. It is usually one person's opinion who writes for a magazine or column. It is the view of only one person and it is one person's opinion. Whereas with the site of embodiments of this invention, if several hundred or thousand people rate the food (e.g., a burger or cheesesteak), the algorithm used in this invention (e.g., as described in U.S. Pat. No. 10,614,430) will return a much more accurate representation of how good or bad the food really is.

### Example 4

Certain embodiments of the invention also provide a method of effecting payment to a Critic that comprises receiving, by a Host Computer System, a Request For Payment from a Critic Computer System, including an amount in a cryptocurrency;
determining, by the Host Computer System, a first exchange rate, wherein the first exchange rate fluctuates and the first exchange rate is determine at a first moment in time;
converting, by the Host Computer System, the amount in the currency to an amount in another, second currency (e.g., Bitcoin) using the first exchange rate at the first moment in time;
receiving, by the Host computer System, a send instruction from the Host Computer System, wherein the send instruction is at a second moment in time later than the first moment in time and the exchange rate at the second moment in time is a second exchange rate that is different than the first exchange rate at the first moment in time;
receiving, by the Host Computer System, payment in the second currency from the Host Computer System in an amount that is based on the amount in the second currency; and
transmitting, by the Host Computer System, in response to receiving the send instruction from the Critic Computer System, a payment instruction to pay currency to the Critic, wherein the currency paid to the Critic is for an amount that is at least in part based on the amount in the currency that is converted to the second currency at the first moment in time even though the exchange rate is different at the second moment in time.

In this method, a Host Computer System comprises a processor, a computer readable medium connected to the processor, and a set of instructions on the computer readable medium that are executable by the processor that perform the steps set forth above. The set of instructions also comprise an Interface that is capable of receiving a Request For Payment from a Critic Computer System, comprising an amount in a first currency and a currency converter determining a first exchange rate.

### Example 5

A particular and exemplary cryptocurrency system application of compensating critics is described. This embodiment includes several components: a website operated by the Host that is resident on a server that is accessed by an app (that may have one or more components, selectively accessible to different users) that is available for smartphones, laptop computers and desktop computers and it can be accessed and downloaded by Critics and Consumers.

The Consumers can access the app and read reviews and/or additional information as describe above. The Critics can access the app and provide reviews and/or additional information and request compensation in the form of cryptocurrency from the Host for the reviews. The Host can provide access to the request and a process for responding to the request for compensation and providing the compensation to the Critics.

This method uses a Host Computer System that can access and interact with the website and app. The Host Computer System comprises a processor connected to a non-transitory computer readable medium that stores information, such medium comprising (a) a plurality of cryptographic key based currency wallets including a Host Wallet and an App Wallet for an App Computer System, and (b) a set of instructions executable by the processor, including a Wallet Management Module; an Interface that receives a Request For Payment from an App Computer System; and a Reference Code Generator that generates a Reference Code for the Request For Payment.

The Host Computer System also comprises: a. a Bank Transfer Module; b. an Account Management Module; and c. a plurality of cryptographic key based currency accounts and capabilities, comprising a Host Account, one or more App Computer Systems, and an App Account, the App Account having an App Wallet and an App Currency for an App Computer System.

The method of this embodiment comprises:
a. receiving, by the Host Computer System, a Request For Payment from an App Computer System;
b. generating, by the Host Computer System, a Reference Code for the Request For Payment; creating, by the Host Computer System, a Locator that includes the Reference Code;
c. transmitting, by the Host Computer System, the Reference Code to the App Computer System as a response to the Request For Payment;
d. receiving, by the Host Computer System, a Locator Request from a Critic that includes the Reference Code;
e. automatically generating, by the Host Computer System, a cryptographic key based currency address within the App Wallet for the Request For Payment;
f. responding to the Locator Request, determining a first exchange rate between the App Currency and a cryptographic key based currency, at a first moment in time, and locking in the first exchange rate for the App Computer System for a predefined period of time;
g. converting, by the Host Computer System, the first amount in the App Currency to a first amount in cryptographic key based currency using the locked in first exchange rate;
h. transmitting, by the Host Computer System, a user interface to the App Computer System in response to the Locator Request, wherein the user interface displays the first amount in cryptographic key based currency and displays a user interface element for transmitting a send instruction to the Host Computer System;
i. receiving, by the Host Computer System, the send instruction for sending a payment from the App Computer System, wherein the send instruction is at a second moment in time later than the first moment in time and the exchange rate at the second moment in time is a second exchange rate that is different than the first exchange rate at the first moment in time;
j. receiving, by the Wallet Management Module, in the App Wallet at the cryptographic key based currency address, by the Host Computer System, payment in cryptographic key based currency from the Critic in an amount that is at least the first amount in cryptographic key based currency;
k. converting, by the Host Computer System, the first amount in the App Currency to a second amount in cryptographic key based currency using the second exchange rate at the second moment in time;
l. providing, by the Host Computer System, an output of a cryptographic key based replacement cost for display on one or more computer systems, wherein the output of the replacement cost is determined by calculating a difference between the first amount in cryptographic key based currency using the first exchange rate and the second amount in cryptographic key based currency using the second exchange rate;
m. transferring the cryptographic key based currency from the App Wallet to the Host Wallet, using the Wallet Management Module, and in response to receiving the cryptographic key based currency from the App Wallet to the Host Wallet; and
n. transmitting, by the Bank Transfer Module, a payment instruction to pay a second amount in App Currency to the App, wherein the second amount in App Currency paid to the App is for an amount that is at least in part based on the first amount in the App Currency that is converted to cryptographic key based currency at the first moment in time.

This embodiment may also interact with a Bitcoin or other network, by transferring, using the Wallet Management Module, the cryptographic key based currency from the App Wallet to the Host Wallet, by broadcasting a message to a Bitcoin or other network.

While certain exemplary embodiments have been described, it is to be understood that such embodiments are merely illustrative and not restrictive of the current invention, and that this invention is not restricted to the specific constructions and arrangements shown and described since modifications may occur to those ordinarily skilled in the art.

What is claimed is:

1. A method of obtaining a critic's critiques and ranking information for food and beverages sold by a bar, restaurant and/or other establishment, the method comprising:
(a) providing a software app to the critic on a smartphone and/or laptop computer, the software app comprising queries for the critic to answer in the form of query answers, the queries comprising critiques of the food and the beverages, rankings of the food and the beverages, pictures of the food and beverages, menus listing the food and beverages, and type of ethnicity of the food and beverages if any;
(b) uploading the query answers to one or more computer servers;
(c) processing the query answers to compile and organize them and providing the processed query answers to a website; and
(d) compensating the critic for the query answers in a manner that allows the critic to claim a profit and deduct at least a portion of the critic's expenses undertaken to provide the query answers under the tax laws of the United States, a state of the United States, and/or another tax jurisdiction of the world.

2. The method of claim 1 wherein the compensation provided by step (d) comprises stock in a corporate entity.

3. The method of claim 1 wherein the compensation provided by step (d) comprises crypto currency.

4. A computer network operating a software app for critiquing and rating food and beverages, comprising:
a plurality of computer devices operating the app and interfaced with a critiquing and rating website hosted on a computer server with access to the Internet and supporting critiques by authorized critics using said computer devices;
the app comprises a comprehensive rating system that includes ratings for take-out, delivery, and in-store dining;
the app provides support for displaying on the website at least-reviews and ratings of food and alcoholic beverages; pictures of dishes; menus from restaurants and pictures of each dish;
rankings of dishes; delineating rankings by ethnicity comprising at least Indian, Chinese, Greek, French, and Italian dishes; aggregate best dish ratings by categories comprised of at least steak, pizza, burgers, and seafood; pie charts of data; top 100 most popular and highest rated dish by locale; and restaurant rankings, including rankings by locale.

5. A method of effecting payment to a Critic for providing critique and ranking information for food and beverages sold by a bar, restaurant, and/or other establishment, using at least a Host Computer System that includes a Bank Transfer Module, an Account Management Module, and a plurality of cryptographic key based currency accounts including a Host Account, one or more App Computer Systems, and an App Account with an App Wallet and an App Currency for an App Computer System, the method comprising:
a. receiving, by the Host Computer System, a Request For Payment from the App Computer System;
b. generating, by the Host Computer System, a Reference Code for the Request For Payment; creating, by the Host Computer System, a Locator that includes the Reference Code;
c. transmitting, by the Host Computer System, the Reference Code to the App Computer System as a response to the Request For Payment;
d. receiving, by the Host Computer System, a Locator Request from a Critic that includes the Reference Code;
e. automatically generating, by the Host Computer System, a cryptographic key based currency address within the App Wallet for the Request For Payment;
f. responding to the Locator Request, determining a first exchange rate between the App Currency and a cryptographic key based currency, at a first moment in time, and locking in the first exchange rate for the App Computer System for a predefined period of time;
g. converting, by the Host Computer System, the first amount in the App Currency to a first amount in cryptographic key based currency using the locked in first exchange rate;
h. transmitting, by the Host Computer System, a user interface to the App Computer System in response to the Locator Request, wherein the user interface displays the first amount in cryptographic key based currency and displays a user interface element for transmitting a send instruction to the Host Computer System;
i. receiving, by the Host Computer System, the send instruction for sending a payment from the App Computer System, wherein the send instruction is at a second moment in time later than the first moment in time and the exchange rate at the second moment in time is a second exchange rate that is different than the first exchange rate at the first moment in time;
j. receiving, by the Wallet Management Module, in the App Wallet at the cryptographic key based currency address, by the Host Computer System, payment in cryptographic key based currency from the Critic in an amount that is at least the first amount in cryptographic key based currency;
k. converting, by the Host Computer System, the first amount in the App Currency to a second amount in cryptographic key based currency using the second exchange rate at the second moment in time;
l. providing, by the Host Computer System, an output of a cryptographic key based replacement cost for display on one or more computer systems, wherein the output of the replacement cost is determined by calculating a difference between the first amount in cryptographic key based currency using the first exchange rate and the second amount in cryptographic key based currency using the second exchange rate;
m. transferring the cryptographic key based currency from the App Wallet to the Host Wallet, using the Wallet Management Module, and in response to receiving the cryptographic key based currency from the App Wallet to the Host Wallet; and
n. transmitting, by the Bank Transfer Module, a payment instruction to pay a second amount in App Currency to the App, wherein the second amount in App Currency paid to the App is for an amount that is at least in part based on the first amount in the App Currency that is converted to cryptographic key based currency at the first moment in time.

6. A graphical user interface, comprised of multiple elements, for a platform for critiquing and rating food and beverages by a user, the graphical user interface further comprising:
a graphical user interface element for displaying and allowing the user to access reviews and ratings of food and alcoholic beverages;
a graphical user interface element for displaying and allowing the user to access pictures of dishes;
a graphical user interface element for displaying and allowing the user to access menus from restaurants and pictures of each dish;
a graphical user interface element for displaying and allowing the user to access rankings of dishes;
a graphical user interface element for displaying and allowing the user to access delineating rankings by ethnicity comprising at least Indian, Chinese, Greek, French, and Italian dishes;
a graphical user interface element for displaying and allowing aggregate best dish ratings by categories comprised of at least steak, pizza, burgers, and seafood;
a graphical user interface element for displaying and allowing the user to access pie charts of data;
a graphical user interface element for displaying and allowing the user to access top 100 most popular and highest rated dish by locale; and
a graphical user interface element for displaying and allowing the user to access restaurant rankings, including rankings by locale.
